(19) United States
(12) Patent Application Publication
(10) Pub. No.: US 2023/0225375 A1
(43) Pub. Date: Jul. 20, 2023

(54) Process and Reactor for Heating at Least One Fluid by Magnetic Induction

(71) Applicant: ETH Zurich, Zürich (CH)

(72) Inventors: Christoph Oliver Blattmann, Richterswil (CH); Leandro Silvano Guido Buchmann, Winterthur (CH); Alexander Mathys, Zürich (CH); Dominik Hug, Pfäffikon (CH)

(21) Appl. No.: 18/010,504

(22) PCT Filed: Jun. 17, 2021
(86) PCT No.: PCT/EP2021/066355

§ 371 Date: Dec. 15, 2022

(30) Foreign Application Priority Data
Jun. 18, 2020 (EP) 20180858.1

(51) Int. Cl. A23L 3/005; A23C 3/03; A23L 2/48

(52) U.S. Cl. CPC A23L 3/005; A23C 3/03; A23L 2/48

(57) ABSTRACT

Provided is a process for heating at least one fluid by magnetic induction using at least one metal as a heat transfer medium. The metal is incorporated into the fluid to be heated as a packed bed. A high frequency alternating magnetic field (AC-field) of at least 50 kHz is applied for generating heat in at least a (thin) interfacial layer of the metal and the generated heat is subsequently transferred to the fluid to be heated.

### CROSS REFERENCE TO RELATED APPLICATIONS

This application is the United States national phase of International Patent Application Number PCT/EP2021/066355, filed Jun. 17, 2021, and claims priority to European Patent Application No. 20180858.1, filed Jun. 18, 2020, the disclosures of which are hereby incorporated by reference in their entireties.

### BACKGROUND OF THE INVENTION

### Field of the Invention

The disclosure relates to a process for heating at least one fluid by magnetic induction and a reactor for carrying out such as process.

### Description of Related Art

Industry still seeks a less destructive solution for processing of pumpable heat sensitive fluids, such as fluids in the food processing industry, but also chemical, biotech or pharmaceutical industry. More explicitly, that means treating the liquid product, such a beverage, in order to make it safe for consumers to drink by removing spoilage-causing pathogens without diminishing quality. By traditional means this is achieved by thermal pasteurization and sterilization during which the liquid is heated above a threshold for sufficient duration (Kessler, H. G. & Horak, F. P. Milchwissenschaft 39, 451-454, 1984). The hereby sought consumer safety comes with a catch: not only are spoilage-causing pathogens removed, but nutrition, taste, appearance and consistency undergo change as well (Kessler H G. Food and Bio Process Engineering: Dairy Technology. Muenchen, Germany: Verlag A. Kessler, 2002). Such product degradation is foreseeable considering constituent stability during high temperature exposure. As a result, higher temperature-time during sterilization elevates product degradation compared to pasteurization.

Food safety is a pursuit of liquid food processors. However, many consumers are becoming more demanding. They expect safety and want a product that otherwise resembles the raw good with superior organoleptic properties: no burnt flavor from Maillard reactions, no degradation of nutrients, such as vitamins and antioxidants, and no appearance change in particular in colorful fruit juices. Naturalness without health risks is trendy.

In order to satisfy consumers, researchers are proposing alternative processing technologies with likewise safety but superior “naturalness”. This has led to the development of technologies like high pressure processing (HPP), pulsed electric field (PEF) processing, ultra-sonication, and electron-beam treatment. None of these technology-challengers have yet mastered to replace traditional thermal processing on broad industrial scales. The field remains open for introducing a new, different means of pathogen decimation. In this context, processes encompassing a conventional temperature rise may be more attractive for uptake by industry as the efficacy of heat is more readily accepted and consumers exhibit less aversion.

Improving product quality while maintaining high safety may be possible thermally through ultra-short pasteurization/sterilization (USP and USS, respectively). USP and USS require extremely rapid heating and subsequent cooling in order to ensure millisecond-range holding times (Morgan, A. I., Radewonuk, E. R. & Scullen, O. J. J Food Sci 61, 1216-1218, 1996). Key for liquids is a large heat exchange area usually associated with microreactors (Mathys, A. Front. Nutr. 5, 24, 2018). Achieving these process conditions for liquids is an ambitious endeavor and, thus, making efficacy rather unexplored. Correspondingly, enabling technology first needs to be developed.

So far liquid food thermal processing by inductive heating has received little attention (Martel, R., Pouliot, Y. & Charette, A. Lait 72, 297-306, 1992) and applicability for USP/USS was disregarded fully. However, tubular packed bed (PB) reactors for liquid heating by induction have been proposed on the macro (Duquenne, P., Deltour, A. & Lacoste, G. Int. J. Heat Mass Transf. 36, 2473-2477, 1993) and micro scale (Ceylan, S., Friese, C., Lammel, C., Mazac, K. & Kirschning, A. Angew. Chem. 47, 8950-8953, 2008). The latter being an attractive solution for rapid, efficient heating of reactions occurring at high temperatures. In that work ‘rapid’ still pertains to much longer durations than required for USP/USS (Mathys, A. Front. Nutr. 5, 24, 2018). Nano-sized and macro-scale particles have been applied in larger reactors. Neither size enable achieving USP/USS conditions (i.e. temperature, time) demanding a priori optimization for attaining strived pursuits. Regulating flow velocity and induction system settings (e.g., electrical current, power and frequency) are effective means for regulating the final fluid outlet temperature during operation. The former influences the residence time at high temperatures that crucially influences possible local overheating. Between operation sequences exchange of metallic heat transfer medium (e.g., dimensions, composition) or coil (e.g., dimensions, number of turns) are viable options for optimizing. Fine-tuning these requires more expertise but may deliver better output quality.

Thermal processing by heat transfer can be distinguished with or without a phase transition. The latter is of particular importance for liquid food processing. Heating is characterized by three consecutive stages: heating, holding, and cooling. Due to the applied temperature-time windows, current thermal processing achieves the desired result at the cost of unwanted biochemical and physical alterations of the product. The relation between wanted and unwanted effects is temperature-time dependent where higher temperatures for shorter times in milliseconds is expected to move the relation towards more wanted/targeted and less unwanted effects. If so, this enables greater product quality.

### SUMMARY OF THE INVENTION

It was, therefore, an object of underlying the proposed solution to provide a process that allows heating fluids at high temperatures for shorter times that overcomes the disadvantages of known processes.

Accordingly, a process for (indirect) heating of at least one fluid is provided, wherein the heating is caused by magnetic induction using at least one metal, preferably of ferritic composition, as heat transfer medium, wherein the metal is incorporated into the fluid to be heated as a packed bed, and wherein a high frequency alternating magnetic field (AC-field) of at least 50 kHz is applied for generating heat in at least a (thin) interfacial layer of the metal. The generated heat subsequently is transferred to the fluid to be heated. The magnetic induction of the metal allows for a homogenous heating of the adjacent fluid.

The fluid to be heated may be a fluid, such as a fluid food, in particular a beverage, like milk or juice. The fluid to be heated also may be a fluid used in the chemical industry, pharmaceutical industry or biotech industry.

The present process allows for ultra-short thermal pasteurization and sterilization of liquids. Inductive heating of a ferritic metal in a tubular reactor enables heating of a passing fluid within fractions of a second. Such ultra-short processing can act as an alternative to current industrial standards that, however, in addition to pathogenic safety should provide more natural taste, appearance and consistency as well as enhanced nutrition by retaining potentially relevant heat sensitive functional ingredients. For example, when heating raw milk certain peptides lose their functionality when heated at certain temperature-time combinations. Furthermore, ultra-short processing reduces, due to short residence times, the formation of certain chemical reactions and their undesirable products, for example Hydroxymethylfurtural (1-1MF) in several food.

In an embodiment of the present process the metal comprises or is made of particles such as spheres with an average diameter between 0.1 and 10 mm, preferably between 0.5 and 8 mm, more preferably between 1 and 4 mm.

The metal may comprise ferritic steel, i.e. a ferritic steel that ideally exhibits high magnetic permeability and low electrical conductivity, in particular a chemically inert ferritic steel with a high chromium and low carbon content.

It is also possible, to use metal particles that are at least partially coated for preventing oxidation and electrical insulation. The coating may be preferably a thin coating in order not to reduce the heat transfer efficiency between metal and the fluid to be heated.

In a further embodiment of the present process the particle packed bed of the at least one metallic material is at least one flat packed bed, resembling, for example, a cone shaped packed bed or a hollow diamond like shaped packed bed (antenna like). By arranging the metallic particles in a packed bed a porous structure is provided and thereby the fluid-exposed specific surface area is increased. It is also possible to provide particles or spheres with an enhanced particle surface roughness.

It is also possible that the packed bed comprises packed metallic particles intermixed with inductively inert ones made of, for example, ceramics, polymers or quartz glasses. Intermixed particles can be of different shape or dimension than metallic particles. Intermixed particles enable electrical insulation between metallic ones. It is conceivable that intermixed inductively inert particles provide a supporting structure (by loose stacking or sintering) for the metallic ones. This in turn allows for a geometrically advantageous arrangement of the metallic particles and can lead to a beneficial penetration of the magnetic field within the packed bed and thus a more favorable and uniform inductive heating. Guiding the flow through and along additional non-metallic structures further facilitates optimization of the fluid's residence time through the packed bed. Thus, in an embodiment the packed be may comprise metallic particles that are either intermixed with inert particles or are embedded into the inert particles.ln yet another embodiment of the present process the flow velocity of the fluid through the packed bed is 1-10 cm/s, preferably 3-8 cm/s, more preferably 5 cm/s, while the residence time of the fluid is between 10 ms and 1 s, preferably 10 ms and 100 ms, when passing the packed bed.

The fluid is heated to a temperature between 80 and 200° C., preferably between 90 and 180° C., more preferably between 95 and 160° C.

As mentioned above a high frequency alternating magnetic field (AC-field) of at least 50 kHz is applied for generating heat in at least a thin interfacial layer of the metallic particles. The AC field is applied by using at least one induction coil with a coil number of 3-25, preferably 5-10. The material of the induction coil is preferably copper with low electrical resistance and the current flow through the induction coil is at least 1.5 kA (AC with 50 kHz frequency).

The present process is conducted in a reactor comprising at least one packed bed of at least one metal as heat transfer medium and at least one alternating magnetic field source associated for inducing inductive heating of at least one metal in the packed bed.

In an embodiment the casing of the reactor is made of material inert to magnetic induction, such as quartz glass, ceramics, plastics, in order to selectively heat the metallic constituents of the packed bed and must resist (local) pressure/temperature conditions and might be of transparent nature for process control. The induction coil as magnetic source may be arranged such that the coil surrounds the outer side of the reactor.

The reactor may also comprise means for controlling the magnetic field strength a) by deflecting the magnetic field towards the tube axis or b) restricting the fluid flow in the tube to a narrow gap concentric to the coil. An antenna-like shape of the metallic packed bed may function as flux guide. The reactor is operated such that a high fluid flow rate, rapid heat transfer and distribution of thermal energy is achieved by high Reynold's number and short heat transfer distances, in particular turbulent flow in narrow channels.

The process and reactor according to the proposed solution allow for sub-second homogeneous heating. This is achieved by preparing an interface with high specific surface area and heating it evenly in the present reactor, e.g. microreactors or flow reactors of inductively heated packed-beds of, e.g., nanoparticles. Product temperatures between 70-190° C. during millisecond holding times is the process window of the solution.

Heating the liquid by magnetic induction has been mostly applied for melting and hardening of metals. It enables efficient (>90% efficiency) transfer of electrical energy to heat. Poor electrical conductivity and low magnetic permeability of fluid foods prevent heating the liquid directly. So, heating occurs indirectly by incorporating a metallic heat transfer medium in the liquid, e.g., nanoparticles or particle packed beds. Its interface is heated through magnetic induction. High frequency alternating magnetic fields (e.g., 50 kHz) enable confining heat generation to a thin interfacial layer in metals. Thus, ferritic steel (i.e. high-chromium and low carbon content) with large magnetic permeability proves itself as beneficial. Its inferior electrical conductivity in comparison to copper or iron, for example, provides further benefit for greater heat generation. The composition of the reactor casing/tube must be inert to magnetic induction (e.g., quartz glass, ceramics, plastics), in order to selectively heat the metallic heat transfer medium. Regulating fluid flow velocity and induction system settings (e.g., electrical current, power and frequency) are effective means for regulating the final fluid outlet temperature during operation. The former influences the residence time at high temperatures. Too low flow may result in local overheating of the fluid. Between operation sequences exchange of metallic heat transfer medium (e.g., dimensions, composition) or coil (e.g., dimensions, number of turns) are viable options for optimizing the process.

In order to achieve high temperatures without local overheating, operation of inductively heated reactor must allow high fluid flow rate and rapid transfer and distribution of thermal energy. The latter is achieved with high Reynold's numbers and short heat transfer distances, or more explicitly, turbulent flow in narrow channels. Correspondingly, homogeneous liquid heating (including both temperature-time and residence time distribution) requires means to control the magnetic field strength by either deflection of the magnetic field towards the tube axis or restriction of fluid flow in the tube to a narrow gap concentric to the coil. An antenna-like shape of the metallic heat transfer medium, e.g., packed bed, enables the former because of its ability to function as flux guide. Practical implementations, such as packed beds of steel spheres or slender tubes with a concentric rod, lead to fluid flow to pass through narrow gaps. In conventional thermal processing narrow gaps can be detrimental for continuous high performance due to fouling and gradual clogging. However, sufficiently short high-temperature residence times, should markedly decrease fouling as inferred from lower expected protein denaturation (i.e. greater nutrient retention). Nonetheless, removing fouling deposits and clogging particulate matter is possible by backwards flushing as well as controllably heating the metallic heat transfer medium, e.g., packed bed, in the absence of liquids through magnetic induction. The latter chars adhering organics that are removed during subsequent flushing.

By ensuring high modularity of the setup, quick exchange of the packed bed and tube allow for easy cleanability as well as process analysis, e.g. quantification of fouling. This feature also offers the opportunity of changing the setup alignment or sequence of the individual parts, depending on e.g. packed bed geometry, flow characteristics and downstream components.

### BRIEF DESCRIPTION OF THE DRAWINGS

The solution will be explained in the following in more detail with reference to the figures.

FIGS. 1 and 2 show a schematic views of surface magnetization and fluid heating ability of a packed bed (PB) according to the solution.

### DESCRIPTION OF THE INVENTION

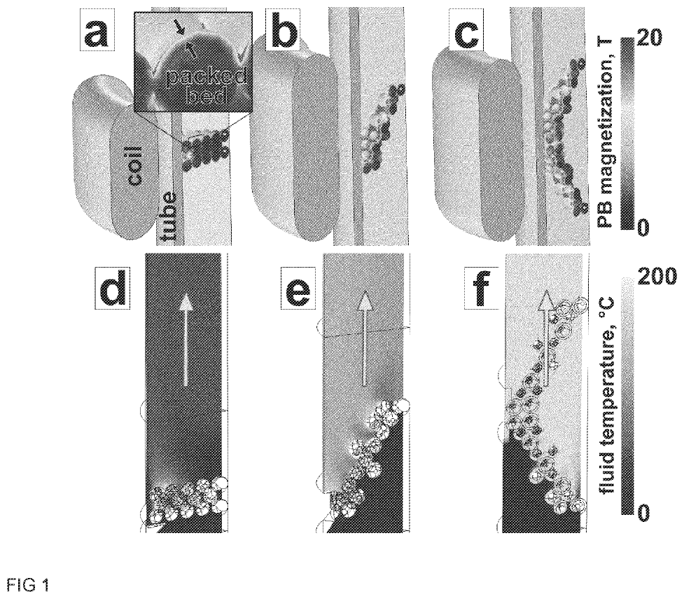

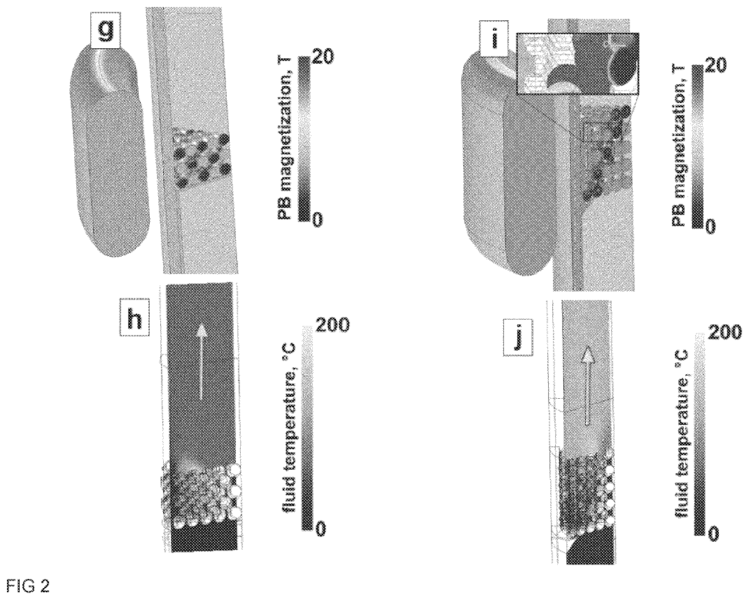

FIGS. 1 and 2 (parts a-j) illustrates various embodiments of a PB according to the solution. A PB of ferritic metal spheres in a tubular reactor (one eighth section) are heated inductively from an alternating (50 kHz) electrical current (1.5 kA) through the surrounding coil (8 turns).

FIGS. 1 and 2 show computed magnetization of a flat (FIG. 1 part a), cone-like (FIG. 1 part b), hollow diamond-like (FIG. 1 part c), a random intermixed (with inert particles) (FIG. 2 part g), and an embedded (in inert particles) (FIG. 2 part i). Increasing PB thickness is ineffective due to magnetization mostly being confined to the external interface as indicted by black arrows in FIG. 1 part a. Magnetization is more homogeneously distributed for antenna-like PB (FIG. 1 parts b and c). A fluid (water) flowing (5 cm s⁻¹, yellow arrow) through the PB is heated. Temperature maps of a cross-section are shown in FIG. 1 parts d, e, f, and FIG. 2 parts h and j. Homogeneity and magnitude of fluid temperature depends on PB morphology.

Increasing the specific surface area of the inductively heated metal, such as by opting for a porous structure (e.g., PB), is an intuitive approach for increasing the heat exchange area. However, inductive heating of the pore interfaces within the metal is not effective for non-isolated and touching PB building blocks due to exponential decay of the internal magnetic field strength (Zinn, S., Semiantin, S. L., Harry, I. L. & Jeffress, R. D. Elements of Induction Heating: Design, Control, and Applications. Carnes Publication Services Inc., 1988) (see FIG. 1 part a). Thick PB structures exhibit no benefit over thin ones. On the contrary, they prolong high-temperature residence time and increase pressure drop.

Realizing high-specific surface area with small particles also exhibits worse heating performance than larger ones due to inferior ability to confine the magnetic field into the particle. A more viable approach for increasing sought high interfacial area is by enhancing particle surface roughness.

In order to achieve high temperatures (FIG. 1 parts d, e f, and FIG. 2 parts h and j without local overheating, operation of inductively heated reactor must allow high fluid flow rate and rapid transfer and distribution of thermal energy. The latter is achieved with high Reynold's numbers and short heat transfer distances, or more explicitly, turbulent flow in narrow channels. Here, a tubular reactor like in Duquenne et al. is investigated (FIG. 1 parts a, b, c, and FIG. 2 parts g and i). The reactor tube composition must be inert to magnetic induction (e.g., quartz glass, ceramics, plastics), in order to selectively heat the metallic heat transfer medium. This assembly exhibits the greatest exerted magnetic field strength at the inner wall of the tube because of its decay towards the coil axis. Correspondingly, homogeneous liquid heating (i.e. temperature and residence time) requires either deflection of the magnetic field towards the tube axis or restriction of fluid flow in the tube to a narrow gap concentric to the coil. An antenna-like shape of the PB (FIG. 1 parts b and c) enables the former because of its ability to function as flux guide (Kondo, T. & Itozaki, H. Physica C 392-396, 1401-1405, 2003). Computational results suggest effectivity in regards to fluid temperature homogeneity and magnitude (FIG. 1 parts d, e, f, and FIG. 2 parts h and j). A centered metallic rod or wire can form a narrow gap between the tube inner wall.

1. A process for heating at least one fluid by magnetic induction using at least one metal as heat transfer medium,
wherein the metal is incorporated into the fluid to be heated as a packed bed, and
wherein a high frequency alternating magnetic field (AC-field) of at least 50 kHz is applied for generating heat in at least a layer of the metal and the generated heat is subsequently transferred to the fluid to be heated.

2. The process according to claim 1, wherein the fluid to be heated is a fluid food, in particular a beverage, like milk or juice, or a fluid used in the chemical industry, pharmaceutical industry or biotech industry.

3. The process according to claim 1, wherein the metal comprises spheres with an average diameter between 0.1 and 10 mm, preferably between 0.5 and 8 mm, and more preferably between 1 and 4 mm.

4. The process according to claim 1, wherein the metal comprises ferritic steel, in particular a chemically inert ferritic steel with a high chromium and low carbon content, with high magnetic permeability and low electrical conductivity.

5. The process according to claim 1, wherein the metal is coated for preventing oxidation and electrical insulation.

6. The process according claim 1, wherein the particle packed bed comprises of metallic particles intermixed with inductively inert particles for providing electrical insulation between metallic particles.

7. The process according to claim 1, wherein packed the particle packed bed comprises metallic particles that are intermixed with inert particles or are embedded into inert particles.

8. The process according to claim 1, wherein the packed bed of the at least one material is at least one flat packed bed, a cone-like shaped packed bed or a hollow diamond-like shaped packed bed.

9. The process according to claim 1, wherein the flow velocity of the fluid through the packed bed is 1-10 cm/s, preferably 3-8 cm/s, more preferably 5 cm/s.

10. The process according to claim 1, wherein the fluid is heated to a temperature between 80 and 200° C., preferably between 90 and 180° C., more preferably between 95 and 160° C.

11. The process according to claim 1, wherein the residence time of the fluid is between 10 ms and 1 s, preferably 10 ms and 100 ms, when passing the packed bed.

12. The process according to claim 1, wherein the alternating magnetic field is applied by using at least one induction coil with a coil number of 3-25, preferably 5-10.

13. A reactor for heating at least one fluid in a process according to claim 1 comprising at least one packed bed of at least one metal as heat transfer medium and at least one alternating magnetic field source associated with the reactor for inductive heating of the at least one metal in the packed bed.

14. The reactor according to claim 13, wherein the reactor casing is made of material inert to magnetic induction, such as glass, ceramics, plastics, in order to selectively heat the metallic heat transfer medium.

15. The reactor according to claim 13, wherein the magnetic source is an induction coil surrounding the outer side of the reactor.

16. The reactor according to claim 13, wherein a centered metallic rod or wire is provided for forming a narrow gap between the tube inner wall.
